(19) United States
(12) Patent Application Publication
(10) Pub. No.: US 2008/0297608 A1
(43) Pub. Date: Dec. 4, 2008

(54) METHOD FOR COOPERATIVE CAPTURE OF IMAGES

(76) Inventors: John N. Border, Walworth, NY (US); David C. Barnum, Rochester, NY (US); Cheryl J. Kuberka, Penfield, NY (US)

Correspondence Address: Frank Pincelli;Patent Legal Staff, Eastman Kodak Compnay, 343 State Street, Rochester, NY, 14650-2201, US

(21) Appl. No.: 11/755,268

(22) Filed: May 30, 2007

(51) Int. Cl. H04N 5/225

(52) U.S. Cl. 348/207.11

(57) ABSTRACT

The present disclosure relates to a system for acquiring images from multiple image capture devices. The system includes a first device coupled to the cooperative network for broadcasting a request to one or more image capture devices participating in the cooperative network for capturing an image at a predetermined location. The system also includes a storage device coupled to the cooperative network for storing the captured image.

### FIELD OF THE INVENTION

The patent pertains to a method for remote capture of digital images based on a cooperative network of digital devices in which at least one of the digital devices has image capture capabilities.

### BACKGROUND OF THE INVENTION

Networks of digital cameras and digital devices are setup to share information including images, and can be operated remotely when connected to a network. Typically, the digital cameras are setup as dedicated image capture devices that can only be operated by remote controllers that can control the image capture timing, pointing or zoom. Alternately, the digital devices are setup to allow images that have been captured to be shared with another digital device.

U.S. Pat. No. 6,400,903 entitled “Remote Camera Relay Controller Method and Apparatus” issued to Conoval discloses a method and apparatus to adapt a digital camera for unattended remote use of the digital camera. The digital camera is controlled remotely by a relay station that retransmits the image data. The digital camera is controlled for field of view, pan, tilt and windowing. However, this approach requires that the digital camera be connected to a network and setup specifically for dedicated remote operation through the relay station by another digital device.

U.S. Pat. No. 6,535,243 issued to Tullis discloses a method for allowing digital cameras access to a large amount of digital image data by using a bidirectional communication medium between the digital camera and a host computer. The method proposed by Tullis focuses on image storage and not image capture.

U.S. Pat. No. 7,154,535 issued to Yamasaki discloses a method for accessing images through a wired or wireless interface to image data resident on another digital camera. Following the method described by Yamasaki, an image is captured by a device and the image along with capture data is sent to another digital device for storage.

U.S. Pat. No. 7,139,018 issued to Grosvenor teaches the sharing of digital images amongst a group of people with image capture devices at the same event. The images are downloaded from the image capture devices to a shared storage location. The images are all labeled with a synchronizing code to enable image sharing of only the images from the event.

The prior art fails to describe a cooperative network of digital devices in which the operator can choose to participate within a group of digital devices that are connected to a common network. The image capture capabilities of the group are shared between those participating in the cooperative network thereby enabling images to be captured from desired locations and with different image capture capabilities from the operator's digital device. What is needed is a way for controlling and capturing a digital image through wired or wireless digital devices such as a cell phones, cell phones with embedded cameras, digital cameras, computers or personal digital assistants (PDAs). Accordingly, an opportunity exists to use available digital devices with image capture capabilities that are connected to a network to capture images cooperatively when requested by another digital device on the network.

### SUMMARY OF THE INVENTION

In general terms, the present disclosure relates to a system and method for a cooperative capturing images, and more particularly to a system and method for acquiring images from multiple image capture devices.

The invention discloses the use of two or more digital devices that can communicate through a network wherein a request to capture an image of a specified location can be transmitted from a first digital device to the one or more other digital devices in the network. Digital devices with image capture capabilities located near the specified location and cooperating in the network can then capture an image of the specified location and transmit the image back to the requesting device for use or storage. The invention further discloses the use of a cooperative capture setting wherein the digital devices with image capture capabilities can be set by the user to respond to request, ignore requests, or limit requests by other digital devices on the network to capture images when requested.

Devices in the network that can be used in the method of the invention can include any type of digital device that can transmit information over a network and can use or store digital images including but not limited to: computers, cell phones, digital cameras, portable digital devices, digital televisions, digital picture frames, or the like. The network can be wireless, landline, cable, digital radio or other types of communication networks. In the spirit of the invention, the digital devices do not have to be setup specifically on the network for remote capture but instead can simply be the many digital devices which are normally present at any group event wherein a number of people are present.

One aspect of the present invention is a method for acquiring images from multiple image capture devices. More particularly, the method includes broadcasting a request to one or more image capture devices participating in a cooperative network for capturing an image at a predetermined location, capturing the image by the one or more image capture device, and storing the requested image in a storage device.

Another aspect of the present invention is a system for acquiring images from multiple image capture devices. More particularly, the system includes a cooperative network, a first device coupled to the cooperative network for broadcasting a request to one or more image capture devices participating in the cooperative network for capturing an image at a predetermined location, and a storage device coupled to the cooperative network for storing the captured image.

Yet another aspect of the present invention is a method for acquiring images from multiple image capture devices. More particularly, the method includes detecting one or more image capture devices in a cooperative network, controlling the operation of the detected one or more image capture devices in the cooperative network for capturing an image at a predetermined location, capturing the image by the one or more image capture device, and storing the requested image in a storage device.

### BRIEF DESCRIPTION OF THE DRAWINGS

The invention may be more completely understood by considering the detailed description of various embodiments of the invention which follows in connection with the accompanying drawings. Referring now to the drawings in which like reference numbers represent corresponding parts throughout:

FIG. 1 is a block diagram of a typical digital device according to one embodiment of the present invention;

FIG. 2 illustrates a diagram of a cooperative network including a variety of digital devices according to one embodiment of the present invention;

FIG. 3 illustrates another embodiment of a cooperative network according to the present invention;

FIG. 4 illustrates an embodiment of a user of a first digital device capturing images during a sporting event via one or more remote digital devices having an image capture modules;

FIG. 5 is a flow chart for determining the global positioning coordinates for a desirable location where an image is to be captured;

FIG. 6 is a flow chart illustrating the acquisition of images from multiple image capture devices according to the present invention; and

FIG. 7 illustrates a geographical map showing a desired image capture location and the location of one or more image capture devices having image capture modules substantially close to the desired location.

### DETAILED DESCRIPTION OF THE INVENTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

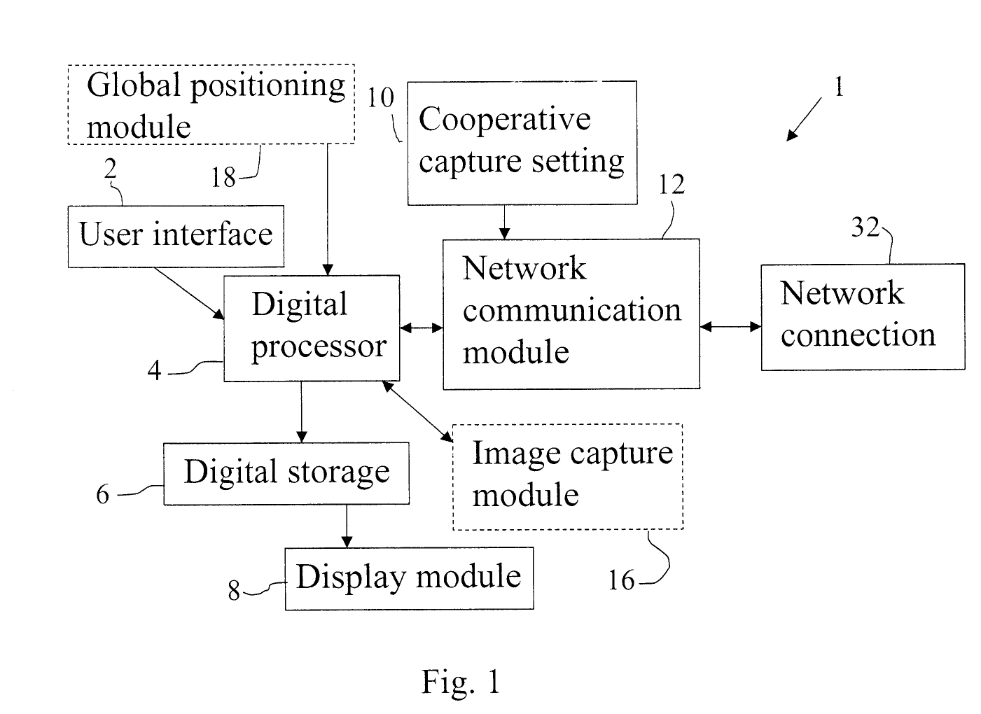

FIG. 1 is a block diagram of a typical digital device 1 according to one embodiment of the present invention. The digital device includes a user interface 2, a digital processor 4, a digital storage module 6, a display module 8, a network communication module 12, a cooperative capture setting 10, and a network connection 32. In one embodiment, the digital device 1 can include an image capture module 16. However, in another embodiment, the digital device 1 does not include an image capture module 16.

In one embodiment, the digital device 1 can also include a global positioning module 18 for determining the location of the digital device 1. However, in another embodiment, the digital device 1 does not include a global positioning module 18 for determining the location of the digital device 1. Multiple digital devices 1 can be connected together through a network connection 32 to create a cooperative network that enables communication between two or more digital devices 1 for various purposes.

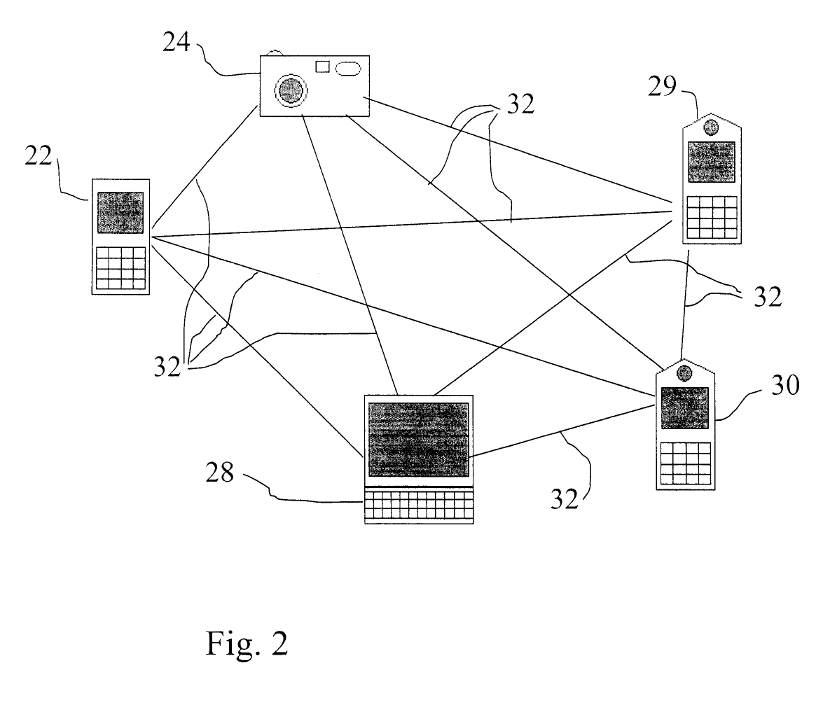

FIG. 2 illustrates a diagram of a cooperative network including a variety of digital devices according to one embodiment of the present invention. The digital devices shown in FIG. 2 are the same or substantially similar to the digital device 1 illustrated in FIG. 1 and include one or more of the following types: a cellular telephone 22, a digital camera 24, a computer 28, a PDA 29 and a cellular telephone with an embedded digital camera 30. The network connections 32 between digital devices 1 can be wireless, landline, radio frequency, infrared or other suitable media or combinations of media for digital communication of information including digital images.

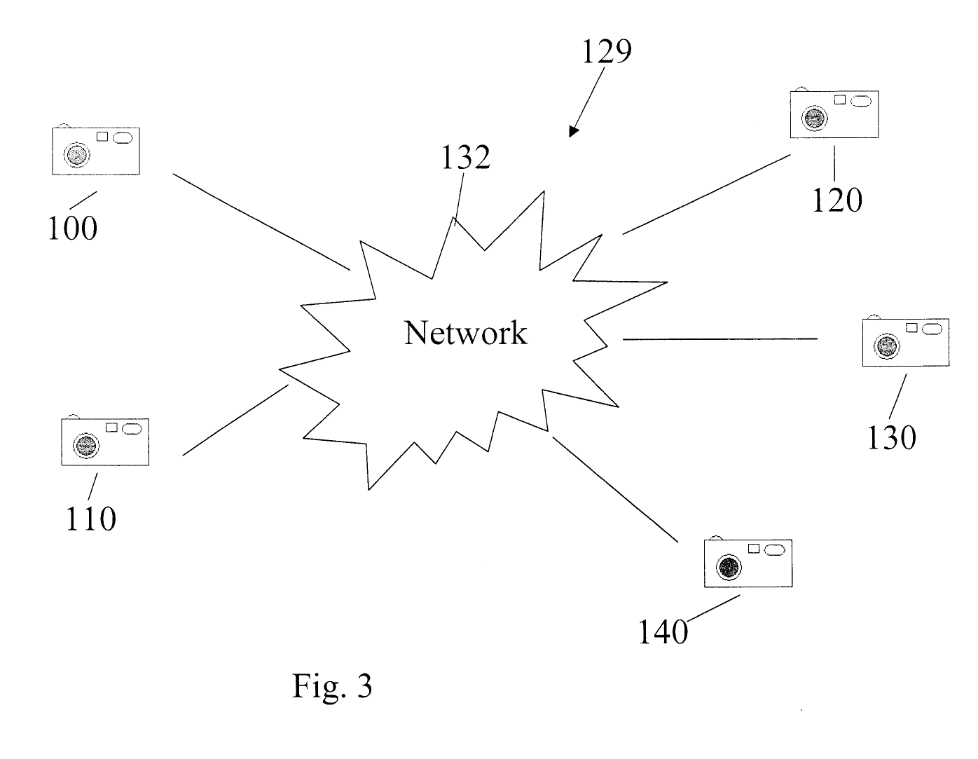

FIG. 3 illustrates another embodiment of a cooperative network 129 according to the present invention. In FIG. 3, digital devices 100, 110, 120, 130, 140 have the same or substantially similar capabilities of digital device 1 of FIG. 1. Each of these digital devices 100, 110, 120, 130, 140 provide cooperative use of an image capture module 16 and are connected by a network connection 132 to form a cooperative network 129.

In a first embodiment of the invention, a request to capture an image at a specified location is transmitted by a user from a first digital device 100 over the network 132. The request includes a specified location for the image to be captured and a range around the specified location wherein the image capture is desired. The request may also include a general or specific compass direction for pointing one or more other digital devices 110, 120, 130 and 140 and a range around the direction. The request to capture the image at the specified location is received by the one or more other digital devices 110, 120, 130 and 140 connected to the network 132. The digital devices 110, 120, 130 and 140 connected to the network 132 then compare the request to their cooperative capture setting. The cooperative capture setting are set by the operators of the digital devices 110, 120, 130 and 140 and are used to, but not limited to, determine whether image capture requests are to be allowed or ignored. Each digital device 110, 120, 130 and 140 with an image capture module 16 then compare its location to the specified location in the request sent from the first digital device 100. If the location of the digital device 110, 120, 130 and 140 with an image module 16 is within the specified range of the specified location and the device cooperative capture setting has been set to allow image captures as requested by other digital devices 1, then an image of the scene is captured and sent to the first digital device 100 over the network connection 132. This image may be captured manually by the user of the other digital device 110, 120, 130 or 140 or automatically with no user intervention as determined by the cooperative capture settings.

The advantage of the technique described, is that a user of digital device 100, for example, can capture images at remote locations using the image capture modules 16 of other digital devices 110, 120, 130 or 140, for example, via the network 132. The digital devices 110, 120, 130 or 140 can be located at a remote location with respect to digital device 100. In a group situation, such as at a sporting event, this can provide improved image capture capabilities for an operator by enabling other digital devices 110, 120, 130 or 140 with image capture modules 16 to be temporarily used. These temporarily used digital devices 110, 120, 130 or 140 provide more desirable images because they are located at locations closer to the action or have a better capture angle. When the network connection 32 (FIG. 2) is a wireless network connection, the difference between locations of the first digital device 100 and the other digital devices 110, 120, 130 and 140 with capture capabilities can be on the order of a few feet or several hundred feet. For example, a digital device 100, 110, 120, 130 or 140 can utilize short-range wireless connections on the order of a few feet, such as a Bluetooth type wireless connection, or a medium range wireless connection on the order of a 100 feet, such as a WIFI connection.

For the case where the network connection 132 is a cellular network, a landline network or a radio network, then the difference in location between the requesting digital device 100 and the other digital devices 110, 120, 130 and 140 with an image capture module 16 can be many miles. For the case where the network connection 132 is a radio network, the distance can be unlimited.

Another advantage provided by the invention is that a digital device without an image capture module 16 can be used to transmit a request for an image capture of a specified location onto the network 132. In this way, the requested images can be captured by the other digital devices 110, 120, 130 or 140 having image modules 16 and transmitted to the digital device that does not have an image capture module 16.

A further advantage is that a request for an image capture can be made from a first digital device 100 to a second digital device 110, 120, 130 or 140 having an image capture module 16 with improved capabilities. For example, the second digital device 110, 120, 130 or 140 can include higher resolution or higher magnification capabilities for obtaining an image with improved image quality over what could be obtained with the first digital device 100.

In a further embodiment, the invention discloses that a network could be setup for assigning a monetary charge by the user of the second digital device 110, 120, 130 or 140 having image capture modules 16 to the user of the first digital device 100. The monetary charge can be for a temporary use of the image capture capabilities of the second digital device 110, 120, 130 or 140.

There are a number of options for determining the specific location of a location that is remote to the first digital device 100. In a first approach, global position coordinates of the specific location can be manually determined by the operator from a map or a database. In a second approach, the global position coordinates of the specific location can be determined based on measuring the global position coordinates of the first digital device 100 and then determining the distance and direction to the specific location. The determination can be made, for example, using measurements from a map or making a rough estimation. In this case, a compass would be required to determine the direction from the digital device 100 to the specified location. The global position coordinates of the specific location can then be calculated by adding the distance and direction to the specific location to the global position coordinates of the first digital device 100. In a third approach, the global position coordinates of the specific location can be measured directly with a rangefinder device such as is described in pending U.S. patent application Ser. No. 11/684,036 by Border (docket 93589) which is incorporated herein by reference.

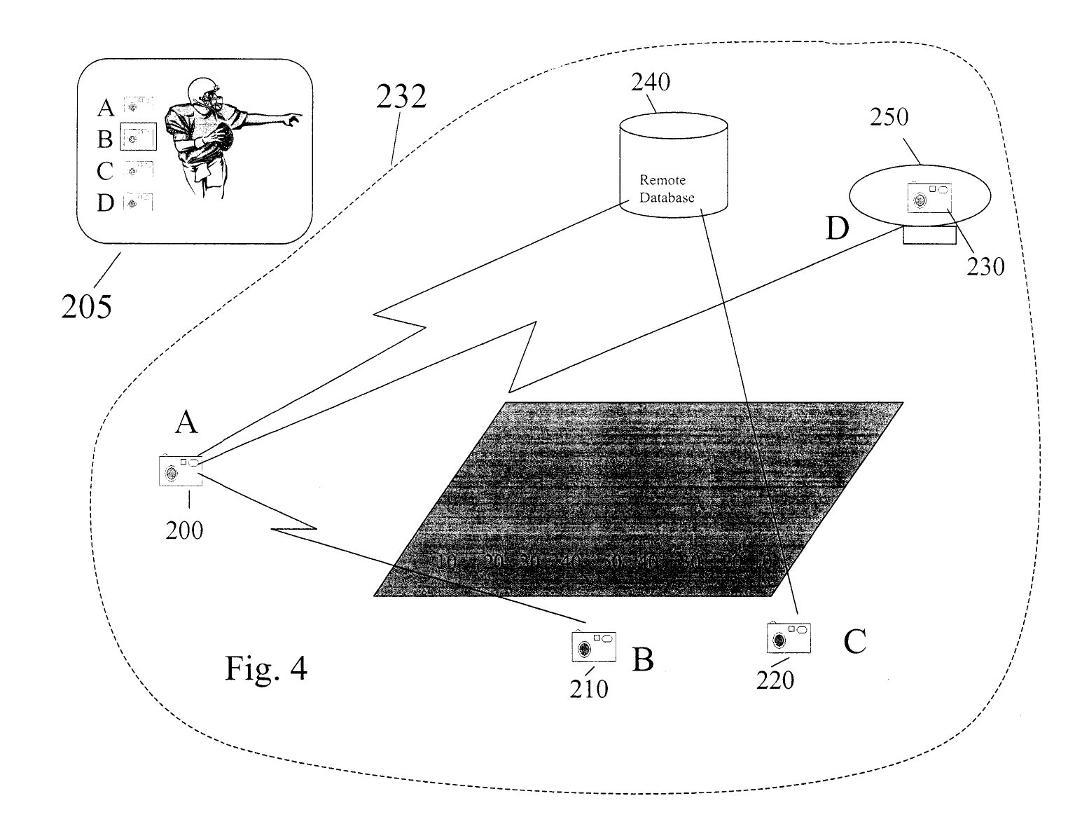

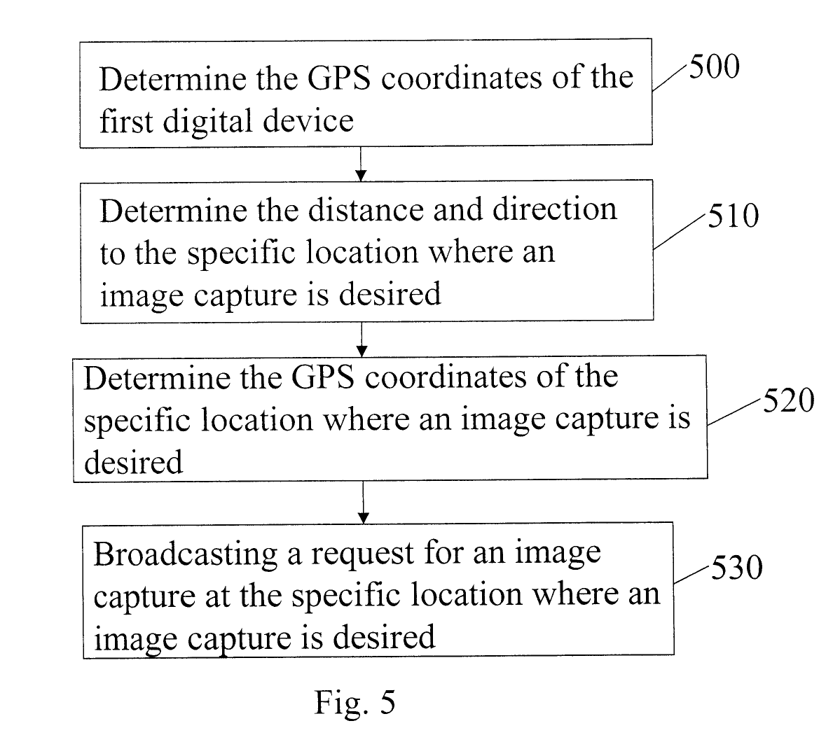

FIG. 4 illustrates an embodiment of a user of a first digital device 200 capturing images during a sporting event via one or more remote digital devices 210, 220 or 230 having an image capture modules 16. In this embodiment, a first user of a first digital device 200 is located at one end of the football field and would like to have images captured at the other end of the football field. The flowchart of FIG. 5 is one technique used to determine the global positioning coordinates for a desired location for image capture with respect to FIG. 4.

FIG. 5 is a flow chart for determining the global positioning coordinates for a desirable location where an image is to be captured. In step 500, the first digital device 200 has a global position module 18 (FIG. 1) that is used to determine the location of the first digital device 200. In step 510, the first digital device 200 uses a digital compass to determine the direction from the first digital device 200 to the specific location where the image is to be captured. A user utilizes this feature by pointing the first digital device 200 toward the specific location where an image is to be captured. In one embodiment, the user of the first digital device 200 then inputs an estimated distance to the specific location where the image capture is desired. In this case, the distance is the length of the football field. However, in another embodiment, the distance to the specific location where an image capture is desired can be measured with a rangefinder. The rangefinder can be built into the digital device such as is described in U.S. patent application Ser. No. 11/684,036 (docket 93589). In this way, the global positioning coordinates of the specific location that the digital device is pointed to can be measured automatically.

In step 520, the first digital device 200 calculates the global position coordinates of the specific location where an image is to be captured based on the global position coordinates of the first digital device 200, the direction to the specific location where the image is to be captured, and the estimated or calculated distance from the first digital device 200 to the specific location where an image capture is desired. In step 530, the user of the first digital device 200 then broadcasts a request to capture the image over the cooperative network 232. The request for the image to be captured at the specific location includes the calculated global position coordinates for the specific location where an image capture is desired and other request information, such as a range around the location that includes the other end of the football field.

Referring back to FIG. 4, the other digital devices 210, 220 and 230 receive the request over the network 232. However, the embodiment is not limited to the immediate network illustrated in FIG. 4, and the network can be any size. These other digital devices 210, 220 and 230 also have global position modules 18. The other digital devices 210, 220 and 230 then compare their respective global position coordinates with the calculated global position coordinates and range included in the request to determine whether they are located close enough to the specific location where an image capture is desired to satisfy the request. In the example shown in FIG. 4, the digital device 210 is located on the side of the football field which is outside of the calculated global position coordinates and range for the specific location where an image capture is desired. Accordingly, the request is ignored by digital device 210. In contrast, digital devices 220 and 230 are both located within the calculated global position coordinates and range where an image capture is desired. Accordingly, both digital devices 220 and 230 can capture images. Digital device 220 provides an image with a field of view from the end line stands whereas digital device 230 provides an image using a field of view from a blimp 250 that is circling over the football field. The two images are then transmitted over the network 232 to storage locations.

Also, FIG. 4 shows that digital device 230 is connected to a wireless network so the image captured is transmitted wirelessly back to the first digital device 200 and stored. In contrast, digital device 220 is connected to a landline network so the image captured is transmitted to a remote database 240 for storage. The image captured by digital device 220 can be accessed at a later time by the user of the first digital device 200 through a wireless network connection to the remote database 240.

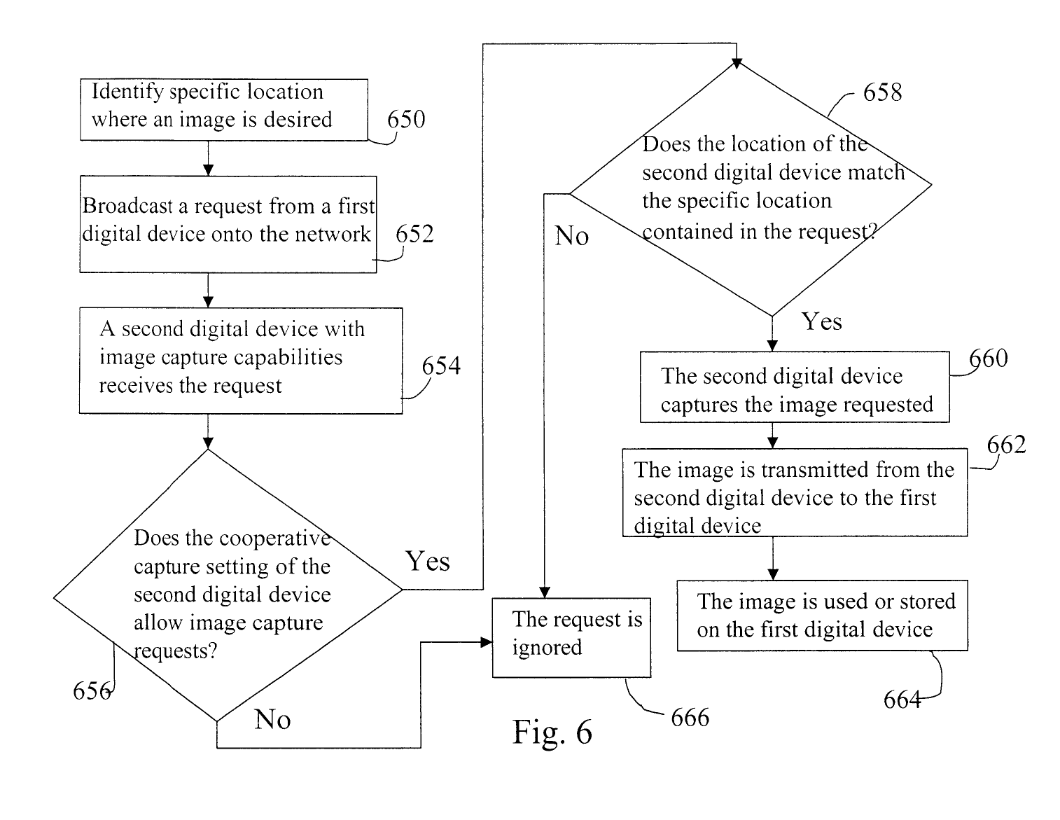

FIG. 6 is a flow chart illustrating the acquisition of images from multiple image capture devices according to the present invention. In step 650 of FIG. 6, an operator identifies a location where an image capture is desired. The location is selected based on a known global positioning location, or based on a difference in global positioning from the location of the first digital device 200 to the desired location. In step 652 the operator uses the user interface 2 (FIG. 1) on the first digital device 200 to broadcast a request onto the network 132. The request is communicated to all the other digital devices 210, 220, 230 that are connected to the network 132. In step 654 the other digital devices 210, 220, 230 receive the request.

In step 656 the other digital devices 210, 220, 230, which have image capture modules 16, compare the request to their cooperative capture settings as set by their respective operators to determine whether requests will be allowed or ignored. If the cooperative capture settings are set such that image capture requests are not allowed, the request is ignored as shown in step 666. If the cooperative capture settings are set such that image capture request is allowed, the process continues to step 658. In step 658, the other digital devices 210, 220, 230 compare their locations as determined by their global positioning modules 18 to the specific location (and associated range) contained in the request from step 652. If the locations of the other digital devices 210, 220, 230 do not match the specific location (or are not within the range associated with the specific location of the request) contained in the request, the request is ignored as in step 666.

If the locations of the other digital devices 210, 220, 230 do match the specific location (or are within the range associated with the specific location of the request), the process then continues to step 660. The other digital devices 210, 220, 230 that match the criterion from steps 656 and 658 capture one or more images as requested. In step 662, the captured images are transmitted from the other digital device 210, 220, 230 to the first digital device 200 through the network 132. In step 664, the captured images are then used or stored by the first digital device 200.

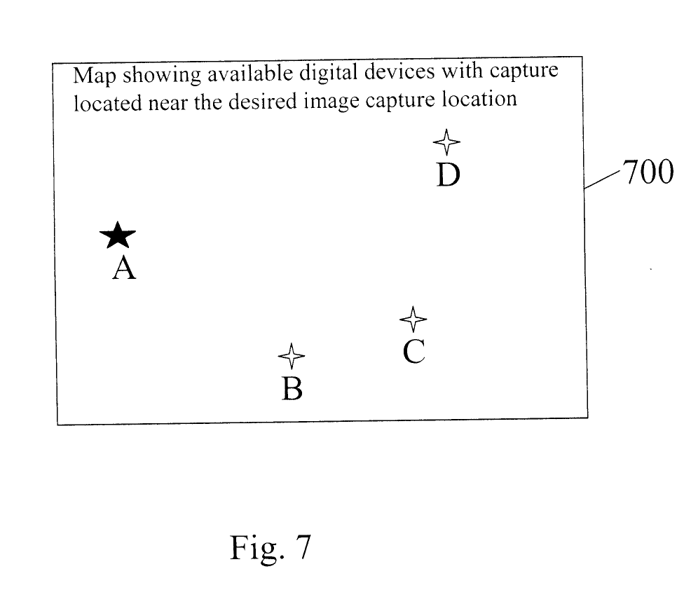

In yet another embodiment, following step 654 wherein a request is received by the other digital devices 210, 220 and 230 from the first digital device 200 or other device, the locations of the other digital devices 210, 220 and 230 are transmitted back to the first digital device 200. The locations of the other digital devices 210, 220 and 230 can then be displayed on the first digital device 200 and the locations of the other digital devices 210, 220 and 230 can be shown relative to the specific location where an image capture is desired. The display of the locations of the other digital devices 210, 220 and 230 relative to the specific location where an image capture is desired can be shown graphical by displaying the global positioning coordinates. Alternatively, the locations of the other digital devices 210, 220 and 230 can be in the form of a map 700 illustrated in FIG. 7. In FIG. 7, the map shows the relative locations B, C and D (FIG. 4) of the other digital devices 210, 220 and 230 and the first digital device 200 (A). The purpose of the display of the map locations of the other digital devices is to enable the user of the first digital device 200 to make a selection from the other digital devices 210, 220 or 230, in which the selection will be used for capturing the desired image. In one embodiment, the map 700 can include a measurement for each digital device 200, 210, 220 and 230 above sea level or above surface hosting the event. In FIG. 4, an enlarged view 205 on the display of the first digital device 200 is shown. The display of the an enlarged view 205 is a continuous video view from digital device 210 that has been selected. An icon showing that digital device B has been selected is also shown on the display (see FIG. 4). However, the embodiment is not limited to display a single digital device, and any suitable number of devices can be viewed on the display, or other displays coupled to the digital device 200.

In still a further embodiment, following step 654, the other digital devices 210, 220 and 230 transmit their locations and a description of their image capture capabilities such as: the number of mega pixels, the zoom range, the type of device such as hand-held, fixed mounted or controllably mounted, and whether a charge will be incurred for the image capture. The description of the image capture capabilities from the other digital devices 210, 220 and 230 can be shown along with the location in a graphical form. However, if the first digital device 200 is displaying a map 700 of the other digital devices 210, 220 and 230, a description of the other digital devices 210, 220 and 230 image capture capabilities can be shown when the icon B, C or D for the available digital device is selected on the map 700 as shown in FIG. 7.

In another embodiment with respect to FIG. 3, a digital device 1 with an image capture module 16 can capture single still images as well as a series of images as in video. As such, the request from the first digital device 100 can be to capture a still image, a video, or a set composed of a combination of a still image and video. Also, the request can be for multiple captures of still images or video. For video, the video can be captured and initially stored on the second digital device 110 then transmitted at a later time to the first digital device 100 to enable high-resolution video to be captured and transmitted without being limited by a low bandwidth network connection. Alternately, the video can be captured by the second digital device 110 and immediately transmitted to the first digital device 100 in streaming video so that the video is viewable on the first digital device 100 in real time.

For still image capture, a cooperative capture setting can be used in the second digital device 110 to allow video captures as requested or to ignore the requests. In a further embodiment, the cooperative capture setting can be set to limit the type of images to be captured. For example, the cooperative capture setting can be set to allow only requested still image captures, to allow requested still image captures and video captures, or to only allow requested video captures. In another embodiment, the cooperative capture setting can include limitations on the still image captures or the video image captures to be allowed. This limitation includes, but not limited to: resolution, time of day, pointing direction, location, image content, modified images which make the images more cartoon like, or some other effect to protect the privacy of the operator of the second digital device 110 and the other people in the image captured by the second digital device 110.

An image capture can include further specifications to the conditions surrounding the image capture such as: the time (including a time range) when the image capture should occur, and the image content based on desired aspects of the image (e.g., number of faces in the image, illumination brightness, colors present, speed of motion, object shapes).

The request for an image capture can even include a portion of an image. This portion of an image is used as an image content example to teach the second digital device to capture an image that contains the image content example. The image content example includes, but is not limited to, a face, an object such as a soccer ball, a number such as on a player's jersey, or other specific image content that is desired in the image to be captured. The portions of an image used as an image content example can be taken from a previously captured image or a previously stored image. This is accomplished by using a touch screen, a mouse, a pointer or other method of selecting portions of an image.

In yet another embodiment, video is immediately transmitted to the first digital device 100 in streaming video so that the video is viewable on the first digital device 100 in real time. A directional indicating system is used and includes a mechanism for communicating the desired change in the pointing direction of the first digital device 100 and a directional change indicator on the second digital device 110, or combinations thereof. In this embodiment, a directional indicating system is used so the user of the first digital device 100 can communicate a request to the user of the second digital device 110 to change the pointing direction of the second digital device 110. As a result, the user of the first digital device 100 can view a different field of view for capturing a video or still image. In operation, the mechanism for communicating the request for a change in pointing direction can include, but is not limited to, a button or a touch screen. The directional change indicator can include, but is not limited to, a series of lights for left, right, and up or down movements. Alternately, the directional change indicator can be shown on the display in the form of an arrow or other directional icon.

For a remotely operated camera that is connected to the network and can provide streaming video, the video is immediately transmitted to the first digital device 100 and is viewable on the first digital device 100 in real time. The user of the first digital device 100 can communicate a request for a change in pointing direction to the remotely operated camera. Provided that the remotely operated camera has movement controllers for changing the pointing direction of the remotely operated camera, the remotely operated camera can change its pointing direction in response to the communicated request.

In another alternate embodiment of the invention, the requested captured images can be transmitted over the network 132 to a remote database 240 for storage and access at a later time. Charges can be assessed to the user for storage and access to the remote database 240.

The following provides several examples of a cooperative capture of images. In a first example, a person with a digital device 100 having wireless connectivity at a sporting event requests an image capture from other digital devices 110, 120, 130 or 140 also at the sporting event. The other digital devices 110, 120, 130 or 140 are within a wireless range from the digital device 100 and it is hoped that some of the other digital devices 110, 120, 130 or 140 include digital cameras 24 (FIG. 2) that have better viewing angles of the action on the field then digital device 100. The person then looks at all the images that are transmitted back from the other digital devices 110, 120, 130 or 140 and chooses the best image to keep or share.

In a second example, a person with a digital device 100 having wireless connectivity but no image capture module, such as a cellular phone 22, requests an image capture from a second digital device 110 at a group event such as a graduation. The second digital device 110 is a cellular phone with an embedded camera 30.

In a third example, a person with a cellular phone 22 requests a 10-minute video capture within the next twenty-four hours from a remote site where the person is planning a vacation. A cellular phone with an image capture module 30 that is located at the remote site captures the video and sends the video back over the cellular phone network.

In a fourth example, a person with a computer 28 connected by landline to the Internet, requests an image capture from Main Street so the person can check on traffic. An image is captured by a PDA 29 connected by WIFI to the Internet that is located at a street side café next to Main Street. The image is captured and transmitted back over the Internet.

In a fifth example, a person with a digital camera 24 having Bluetooth connectivity requests an image capture of himself or herself at an award ceremony where the person is receiving an award. The person hopes that someone else at the award ceremony will have a digital device with cooperative capture settings that will allow the request for image captures.

In a sixth example, a person with a cellular phone 22 requests a video capture from a location inside a store. The store has a digital camera 24 located inside a store that has cooperative capture settings that allow image capture requests. The digital camera 24 in the store is pointed at a scene that shows what type of merchandise the store offers.

In a seventh example, a store positions a digital camera 24 with short-range wireless connectivity and cooperative capture settings that allow image capture requests. Items on sale in the store are in the field of view of the digital camera 24. People wishing to view what is on sale can then request images to be captured from a specific location of the store and transmit those images to people having digital devices connected to the cooperative network as they walk past the store. Alternately, the request for images to be captured can be for multiple still captures or continuous video captures from digital devices located within a short range of the requester's digital device. Thus, the user would receive a series of different images as the user walks past a series of stores.

In an eighth example, a person positions a digital camera 24 with cellular telephone connectivity at a location having a good viewing angle of a major event, such as a concert, a sporting event or a war zone. The digital camera has the cooperative capture setting set to allow image capture requests of still and continuous streaming video. People wishing to view the major event can then request images to be captured from the specific location of the major event. The operator of the digital camera 24 can then assess charges for each image captured and bill the requesters accordingly over the cellular telephone network billing system.

In a ninth example, a person attending a concert or sporting event that has friends who could not make it to the concert can set the cooperative capture settings on a cellular phone with an embedded camera 30. Accordingly, this allows image capture requests of still images, videos or continuous video of the concert or sporting event over the network 132. In this way, the friends can request still images, videos or continuous video from the concert or sporting event over the network and the person attending the concert or sporting event can charge each of the friends a fee for the use of their cellular phone with an embedded camera 30.

In a final example, a person attending a soccer game requests multiple still images throughout the soccer game. The request specifies that an image should be captured whenever the soccer ball and the number of the person's favorite player are both in the image at a location that corresponds to the soccer goal. In this case, the person uses a previous image of the favorite player with a soccer ball. Selected portions of the previous image are included with the request as an image content examples which show the soccer ball and the favorite player's jersey number. By the end of the game, the person receives a number of images that contain the favorite player and the soccer ball in the region of the soccer goal.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

### PARTS LIST

1 digital device
2 user interface
4 digital processor
6 digital storage module
8 display module
10 cooperative capture setting
12 network communication module
16 image capture module
18 global positioning module
22 cellular telephone
24 digital camera
28 computer
29 personal digital assistant (PDA)
30 cellular telephone with embedded digital camera
32 network connection
100 digital device
110 digital device
120 digital device
129 cooperative network
130 digital device
132 network connection
140 digital device
200 digital device with wireless network connection
205 enlarged view
210 digital device with wireless network connection
220 digital device with landline network connection
230 digital device with wireless connection
232 network
240 remote database
250 blimp
500 step of determining the GPS coordinates of the first digital device
510 step of determining the distance and direction from the first digital device to the specific location where an image capture is desired
520 step of determining the GPS coordinates of the specific location where an image capture is desired
530 step of broadcasting a request for an image capture at a specific location
650 step of identifying the specific location where an image capture is desired
652 step of broadcasting a request on a network from a first digital device
654 step of receiving a request by one or more other digital devices
656 step of comparing whether the cooperative capture setting of the one or more digital devices allows image capture requests
658 step of comparing the location of the one or more other digital devices to the location included in the request
660 step of capturing the image as requested
662 step of transmitting the captured image from the one or more other digital devices back to the first digital device
664 step of using or storing the captured image on the first digital device
666 step of ignoring request
700 map showing available digital devices with image capture modules located near the desired image capture location

1. A method for acquiring images from multiple image capture devices comprising:
broadcasting a request to one or more image capture devices participating in a cooperative network for capturing an image at a predetermined location;
capturing the image by the one or more image capture device; and
storing the requested image in a storage device.

2. The method of claim 1, wherein capturing the image by the one or more image capture devices further comprises capturing the image by the one or more image capture devices that are substantially close to the predetermined location.

3. The method of claim 1, wherein capturing the image by the one or more image capture devices further comprises capturing the image at a requested time.

4. The method of claim 1, wherein broadcasting the request further comprises transmitting an image capture request from a first device to one or more image capture devices in the cooperative network.

5. The method of claim 4 further comprising:
receiving the image capture request by the one or more image capture devices in the cooperative network;
capturing the transmitted image capture request by the one or more image capture devices; and
transmitting a captured image by the one or more image capture device to the first device via the network.

6. The method of claim 5, wherein receiving the transmitted image capture request further comprises processing the image capture request when a first cooperative capture setting on the one or more image capture devices is set.

7. The method of claim 6, wherein processing the image capture request further comprises processing one or more additional cooperative capture settings selected from a group consisting of capture resolution, capture direction, capture location, image content, cartoon-like imaging only, video image only, still image only, audio, no-audio, time and date.

8. The method of claim 5, wherein receiving the transmitted image capture request further comprises ignoring the image capture request when a first cooperative capture setting on the one or more remote image capture devices is not set.

9. The method of claim 4, wherein transmitting a request further comprises transmitting a request selected from a group consisting of location instruction, range from desired object, capture direction, video image, still image, resolution, audio, time, image content example, and multiple image capture.

10. The method of claim 4, wherein requesting an image further comprises viewing a data stream from the first device in the cooperative network.

11. The method of claim 10, wherein requesting an image further comprises remotely controlling the one or more image capture devices in the cooperative network from the first device for capturing the image.

12. The method of claim 4, wherein transmitting the image capture request from a first device further comprises transmitting the image capture request from a device selected from a group consisting of a cellular phone, computer, digital camera, cellular phone with embedded camera, personal digital assistant and a digital picture frame.

13. The method of claim 1, wherein capturing the image further comprises capturing an image selected from a group consisting of a still image, video image, continuous video and combination thereof.

14. The method of claim 1, wherein broadcasting a request further comprises requesting the image to be captured from a device having image capture capabilities.

15. The method of claim 1, wherein broadcasting a request further comprises requesting the image to be captured from a device not having image capture capabilities.

16. The method of claim 1, wherein broadcasting a request further comprises requesting an image via a wireless network.

17. The method of claim 1 further comprising charging for the captured images by the one or more image capture device.

18. A system for acquiring images from multiple image capture devices:
a cooperative network;
a first device coupled to the cooperative network for broadcasting a request to one or more image capture devices participating in the cooperative network for capturing an image at a predetermined location; and
a storage device coupled to the cooperative network for storing the captured image.

19. The system of claim 18, wherein the one or more image capture device capture an image substantially close to the predetermined location.

20. The system of claim 18, wherein the one or more image capture devices capture the image at a requested time.

21. The system of claim 18, wherein the one or more image capture devices receive the transmitted image capture request via the cooperative network and transmit a captured image to the first device.

22. The system of claim 18, wherein the one or more image capture devices further comprises a processor for processing a first parameter of the image capture request when the cooperative capture setting of the one or more image capture devices is set.

23. The system of claim 22, wherein the one or more image capture devices process one or more additional image capture parameters of the image capture request selected from a group consisting of capture resolution, capture direction, capture location, image content, cartoon-like imaging only, video image only, still image only, audio, no-audio, time and date.

24. The system of claim 18, wherein the one or more image capture devices ignore the image capture request when a first parameter of the image capture request when the cooperative capture setting of the one or more image capture devices is not set.

25. The system of claim 18, wherein the first device transmits a request selected from a group consisting of location instruction, range from desired object, capture direction, video image, still image, resolution, audio, time, image content example, and multiple image capture.

26. The system of claim 18, wherein the first device further comprises a display for viewing a data stream from the one or more image capture devices in the cooperative network.

27. The system of claim 26, wherein the first device further comprises a controller for remotely controlling the one or more remote image capture devices in the cooperative network for capturing the image.

28. The system of claim 27, wherein the first device further comprises a means for requesting the one or more image capture devices to change the viewing direction and a means for receiving the request by the one or more image capture devices to change the viewing direction.

29. The system of claim 18, wherein the first device transmits the image capture request from a group consisting of a cellular phone, computer, digital camera, cellular phone with embedded camera, personal digital assistant and a digital picture frame.

30. The system of claim 18, wherein the first device captures an image selected from a group consisting of a still image, video image, continuous video and combination thereof.

31. The system of claim 18, wherein the first device has image capture capabilities.

32. The system of claim 18, wherein the first device does not have image capture capabilities.

33. The system of claim 18, wherein the first device broadcasts over a request via a wireless network.

34. The system of claim 18 further comprising charging for the captured images by the one or more image capture device.

35. A method for acquiring images from multiple image capture devices:
detecting one or more image capture devices in a cooperative network;
controlling the operation of the detected one or more image capture devices in the cooperative network for capturing an image at a predetermined location;
capturing the image by the one or more image capture device; and
storing the requested image in a storage device.
